(19) United States
(12) Patent Application Publication
(10) Pub. No.: US 2004/0205931 A1
(43) Pub. Date: Oct. 21, 2004

(54) Door closer structure

(76) Inventor: Tan-Cheng Huang, Taichung (TW)

Correspondence Address: CHARLES E. BAXLEY, ESQUIRE, Fifth Floor, 59 John Street, New York, NY, 10038, US

(21) Appl. No.: 10/418,013

(22) Filed: Apr. 18, 2003

(51) Int. Cl. E05F 1/08

(52) U.S. Cl. 16/79

(57) ABSTRACT

A door closer structure includes a door shaft, a housing, a sliding member, a door-closing spring, a claw, an abutting member and a door-opening spring. The door shaft is utilized to drive a sliding member in a housing, between an end of the sliding member and the housing the door-closing spring is tensioned, and another end of the sliding member is engaged with the abutting member and a sliding board respectively in turn, between the sliding board and the housing a door-opening spring and a claw are disposed respectively, the claw is position-locked on the sliding board, and which can be locked and fastened to the adjustable rod of the housing. The abutting member may be driven by the sliding member so as to unlock and release the claw from the inner side of it.

### BACKGROUND OF THE INVENTION

1. Field of the Invention

The present invention relates to a door closer structure, and more particularly to an auxiliary structure applied to vary kinds of doors and/or windows, which is specially a door closer driven by virtue of the door shaft; the door closer is interiorly provided with a sliding member, a door-closing spring, a door-opening spring and a claw such that not only provide effective assistant door-opening/closing force but also substitute the low-cost spring device for the expensive hydraulic system.

2. Description of the Prior Arts

The conventional door closers sold in market normally utilize hydraulic or pneumatic system as a buffer to exerted force. The hydraulic (pneumatic) door closer is located between the door and a wall to provide buffering effect at the terminal of a door opening or closing action. This kind of hydraulic (pneumatic) door closer has been commonly applied to all kinds of doors and windows, however, there are still some disadvantages will be resulted from real operation as follows:

First, due to the conventional hydraulic (pneumatic) door closer is not provided with motor power, the buffering and door-closing effect are resulted from the reverse pressure and flow of the air or liquid after a compression, in this case, this kind of conventional door closer can only to provide door-closing effect and the terminal buffering effect.

Second, the conventional hydraulic (pneumatic) door closer is very expensive, the pipeline, leak-resistant member, liquid oil of which are all high-cost. Moreover, the pipeline of which must be thickened and no gas hole are accepted, and sealing member required being disposed between the pipelines as well as between the piston and cylinder. Thereby the price of the hydraulic (pneumatic) system is very high.

The present invention has arisen to mitigate and/or obviate the afore-described disadvantages of the conventional door closer structure.

### SUMMARY OF THE INVENTION

In accordance with one aspect of the present invention, there is provided a door closer structure, in which, a door shaft is utilized to drive a sliding member in a housing of the door closer, between an end of the sliding member and the housing a door-closing spring is tensioned, and another end of the sliding member is engaged with an abutting member, a tubular member and a sliding board respectively in turn, between the sliding board and the housing a door-opening spring and a claw are disposed respectively, the claw is position-locked on the sliding board and the same can be pushed by the sliding member and then to be locked and fastened to the adjustable rod of the housing, in addition, the abutting member may be driven by the sliding member so as to unlock and release the claw from the inner side.

The primary objective of the present invention is to provide a door close structure having an ability of providing an effective terminal buffering effect, assistant door-opening force and door-closing force.

Another objective of the present invention is to provide a door closer structure that is cheap and utilize the low-cost spring members to substitute for the expensive hydraulic (pneumatic) system.

The further objective of the present invention is to provide a door closer structure, the buffering distance and assistant force of which can be adjusted without difficulties.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a door closer structure in accordance with a first embodiment of the present invention;

FIG. 2 is cross sectional view of the door closer structure in accordance with a first embodiment of the present invention;

FIG. 3 is another cross sectional view of the door closer structure in accordance with a first embodiment of the present invention;

FIG. 4 is another cross sectional view of the door closer structure in accordance with a first embodiment of the present invention;

FIG. 5 is an exploded view of the door closer structure in accordance with a second embodiment of the present invention;

FIG. 6 is cross sectional view of the door closer structure in accordance with a second embodiment of the present invention;

FIG. 7 is cross sectional view of the door closer structure in accordance with a third embodiment of the present invention;

FIG. 8 is an exploded view of the door closer structure in accordance with a fourth embodiment of the present invention;

FIG. 9 is cross sectional view of the door closer structure in accordance with a fourth embodiment of the present invention;

FIG. 10 is cross sectional view of the door closer structure in accordance with a fifth embodiment of the present invention.

### DETAILED DESCRIPTION OF THE PREFERRED EMBODIMENTS

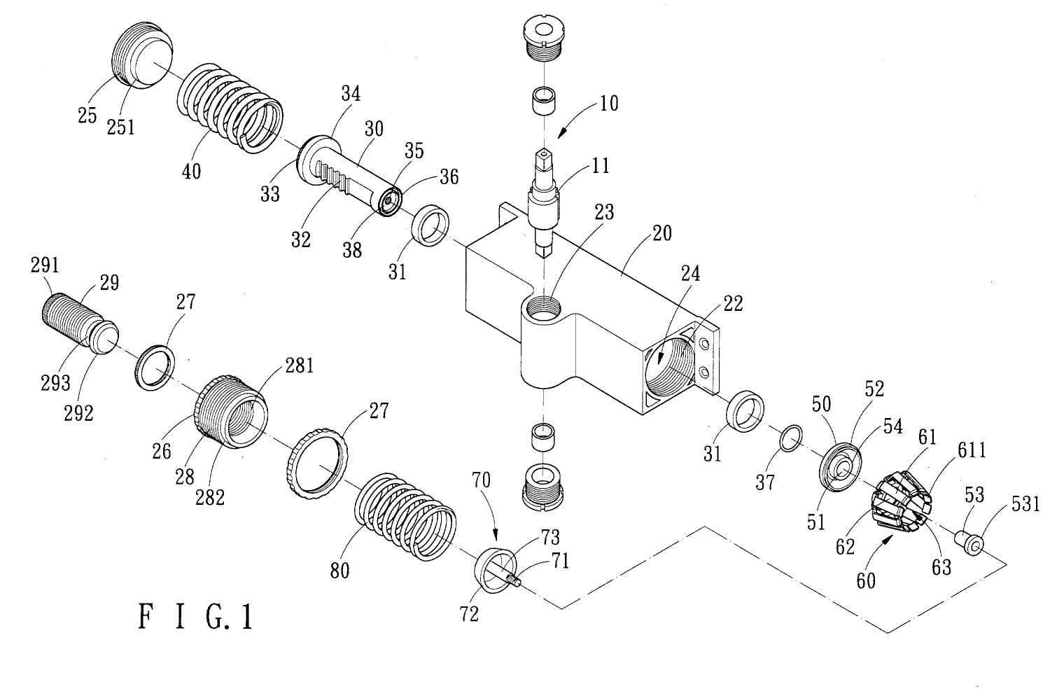

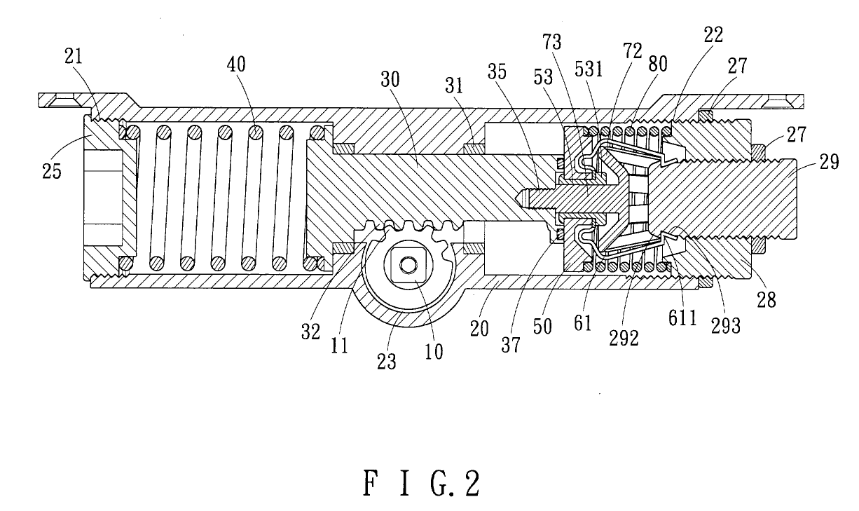

Referring to FIGS. 1-2, wherein a door closer structure in accordance with a first embodiment of the present invention is shown and generally includes a door shaft 10, a housing 20, a sliding member 30, a door-closing spring 40, a sliding board 50, a claw 60, an abutting member 70 and a door-opening spring 80.

The door shaft 10 is provided with a toothed portion 11 and revolves along with the opening and closing action of the door.

The housing 20 has an internal space 24 interiorly defined thereof and at both ends of which are provided with first inner threads 21 and second inner threads 22 respectively. In the middle of the housing 20 a hole 23 is defined for receiving the door shaft 10 therein along with the toothed portion 11 of the door shaft 10 accommodated in the internal space 24 of the housing 20. A spring cover 25 is formed with an annular dent 251 at an end and to be engaged with the first inner threads 21. While an adjusting cover 28 having a plurality of anti-skid knurls 26 defined at the periphery of an end and then to be engaged with the second inner threads 22 by virtue of a screw nut 27. The second cover 28 has a threaded hole 281 formed in the center of the same and about the periphery of another end an annular dent 282 is formed. An adjustable bolt 29 serves to screw in the threaded hole 281 by virtue of another screw nut 27. About periphery of the end of the adjustable bolt 29 a plurality of knurls 291 are defined, and at another end of the same corresponding to the internal space 24 is provided with a chamfer 292 and contiguous to it an engaging portion 293 is defined.

The sliding member 30 is movably accommodated in the internal space 24 of the housing 20 by virtue of a pair of abrasion-resistant gaskets 31. The sliding member 30 has a flanged first end 34 with an annular dent 33 defined thereof and a second end formed with a threaded hole 35, a first annular groove 36 and a second annular groove 38 respectively. The annular dent 33 corresponding to the annular dent 251 of the spring cover 25 in the housing 20, while in the annular groove 36 a cushion ring 37 is received with corresponding to the adjusting cover 28. The sliding member 30 is provided with a plurality of teeth 32 at the outer periphery for engaging with the toothed portion 11 of the door shaft 10.

The door-closing spring 40 serves to provide force for closing door and tensioned between the spring cover 25 of the housing 20 and the flanged first end 34 of the sliding member 30, with a first end abutting against the annular dent 251 of the spring cover 25 and a second end abutting against the annular dent 33 of the flanged first end 34.

The sliding board 50 is received in the internal space 24 of the housing 20 and simultaneously abutting against the cushion ring 37 of the sliding member 30. At the center of the sliding board 50 is provided with a projection 54, and at the center of projection 54 an aperture 51 is defined. The sliding board 50 is further provided with an annular dent 52 about the periphery where corresponding to the adjusting cover 28. A tubular member 53 is inserted into the aperture 51 and has a flange 531 corresponding to the surface of the projection 54, while an end of which is correspondingly received in the second annular groove 38 of the sliding member 30.

The claw 60 is integrally formed by a plurality of plates 61. At the conjunction end of the whole plates 61 an opening 62 is defined, while at another end of the same an open mouth 63 is formed thereof. Each plate 61 is provided with a protruded portion 611 at the end corresponding to the open mouth 63 which corresponding to the engaging portion 293 of the adjustable bolt 29 in the housing 20. The opening 62 of the claw 60 is position-locked by virtue of the flange 531 of the tubular member 53 together with the projection 54 of the sliding board 50.

The abutting member 70 is received in the space 24 of the housing 20, which is provided with a rod 73 at the end corresponding to the sliding member 30 and an annular protrusion 72 at the other end. The rod 73 has threads 71 defined at the end serves for engaging with the threaded hole 35 of the sliding member 30, meanwhile, the rod 73 is movably inserted in the tubular member 53 of the sliding board 50 with the annular protrusion 72 abutting against the inner side of the plates 61 of the claw 60.

The door-opening spring 80 serves to provide buffering force in case of closing the door and the elastic force for opening the door, which is tensioned between the adjusting cover 28 of the housing 20 and the sliding board 50 with a first end abutting against the annular dent 282 of the adjusting cover 28 and a second end abutting against the annular dent 52 of the sliding board 50.

Referring now to FIGS. 2-4, in case of the door is in a closed state (with referring to FIG. 2), the sliding member 30 is pushed toward the terminal of the adjusting cover 28 by virtue of the expansion force of the spring 40. Meanwhile, the sliding board 50 is driven to move towards the adjusting cover 28. Due to an end face of the sliding board 50 abuts against the door-opening spring 80, while the door-opening spring 80 have its first end abutting against the sliding board 50 and second end abutting against the adjusting cover 28, accordingly the door-opening spring 80 is compressed. As the sliding member 30 is approaching the terminal of the adjusting cover 28 and so is the claw 60. While the plates 61 of the claw 60 will together to accommodate the end of the adjustable bolt 29 in the open mouth 63 with the protruded portions 611 of each plate 61 engaged in the engaging portion 293 of the adjustable bolt 29. At the same time, the claw 60 confines the door-opening spring 80 such that the restoring force of it cannot be released. However, the door-closing spring 40 starts to expand and provides a predetermined force to the sliding member 30 so as to help in locking position of the claw 60. By such a manner, in case of a state of door closed, the door closer structure of the present invention will maintain a predetermined force of door closing such that the door will not be opened by itself or by a breeze.

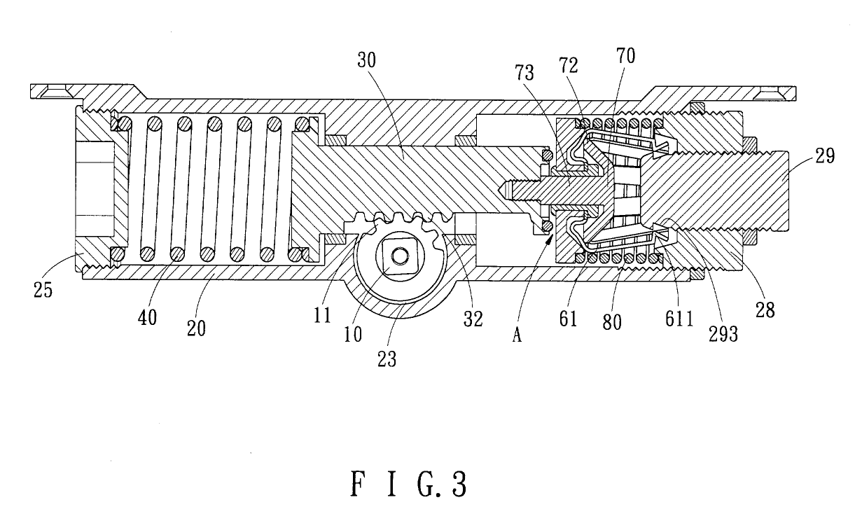

In case that the door being pushed by an user (with referring to FIG. 3), the toothed portion 11 of the door shaft 10 fits the teeth 32 to push the sliding member 30 toward the end of the spring cover 25. And then the abutting member 70 is driven to move toward the spring cover 25. Thereby, the annular protrusion 72 of the abutting member 70 will push against the inner side of the respective plates 61 of the claw 60 such that a transient clearance A appears between the sliding member 30 and the sliding board 50. Due to the portions of the each plate 61 corresponding to the annular protrusion 72 are all metal plates with predetermined gradient, accordingly the protruded portions 611 of the plates 61 will stretch outward with approximately vertical to the axial direction in case that the same are horizontally pushed by the annular protrusion 72. The claw 60 will not confine the door-opening spring 80 anymore until the protruded portion 611 of the plates 61 detached from the engaging portion 293 of the adjustable bolt 29, and then the door-opening spring 80 is free from the claw 60 and starts to release its restoring force (ever greatest elasticity) so as to push the sliding board 50 towards the sliding member 30 (the sliding board 50 contacts the cushion ring 37 first and then abuts against the sliding member 30), the door-opening spring 80 pushes with its ever greatest expansion force at the moment. While the door-closing spring 40 only has a rather minor elastic force, thus the force of the door-opening spring 80 will reduce or counteract that of the door-closing spring 40. By such a manner, in case that the user pushes the door slightly, the door-opening spring 80 will provide a predetermined assistant force to open the door, such that the user almost needless to use his strength to open the door and the door may be opened (similar with the automatic door). Thereby, the door closer structure in accordance with the present invention has an assistant force of door opening.

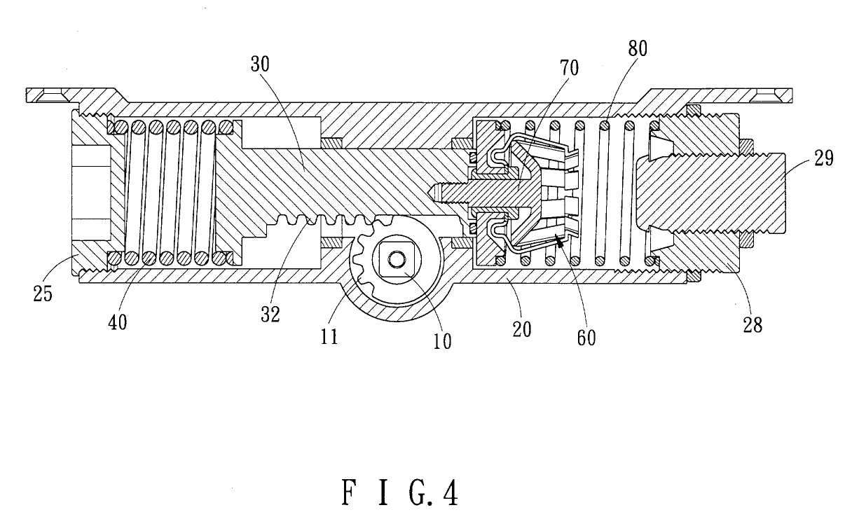

In case that the door is opened to the ultimate (with referring to FIG. 4), the force of the door-opening spring 80 is weakened (in an expanded state), while the elastic force of the door-closing spring 40 is reinforced (in a compressive state). Thereby the force of the door-closing spring 40 is great enough to counteract that of the door-closing spring 40 as well as the pushing force of the user, and to act as a reinforced buffering force such that will effect no impact nor noise but a buffering force with respect to the door-opening force. And then, in case that the user releases the door panel (or close it by hand), the door-closing spring 40 will provide a rather great restoring force to close the door. The door-closing spring 40 expanded to release and force the door-opening spring 80 to be compressed while storing energy, the more the door is closed to the ultimate, the more weaker the expansion force of the door-closing spring 40 becomes while the more great the compression force of the door-opening spring 80 becomes. Thereby the closer to the ultimate, the more great the buffering force becomes such that the door closer of the present invention has an assistant force in door-closing. When the door is closed to the ultimate, the door-closing spring 40 will push the sliding member 30 toward the adjusting cover 28 while the teeth 32 will drive the door shaft 10 to revolve. At the moment, the door-opening spring 80 will provide a buffering force for preventing the strikes and noises. Once the plates 61 contacts the adjustable bolt 29, the protruded portion 611 of the respective plates 61 will slide over the chamfer 292 of the adjustable bolt 29 (the end of the adjustable bolt 29 is retained in the open mouth 63) with the protruded portion 611 of the plates 61 re-retained in the engaging portion 293. At this moment, despite the door-opening spring 80 has accumulated restoring force, which cannot be released due to confined by the claw 60.

It will be noted that make use of low-cost door-closing spring 40, claw 60 and door-opening spring 80 as substitution for expensive pneumatic (hydraulic) system to achieve a buffering and assistant effect, such that the production cost is saved.

On the other hand, the adjusting cover 28 of the housing 20 is engaged with the second inner threads 22 cooperated with a screw nut 27, while the door-opening spring 80 is tensioned between the adjusting cover 28 of the housing 20 and the sliding board 50. By such a manner, the adjusting cover 28 and the adjustable bolt 29 may be driven back and forth by rotating the anti-skid knurling 26, 291 of the same respectively and with adjusting the back and forth of the adjusting cover 28 to adjust the elastic force of the door-opening spring 80 while adjusting the distance between the claw 60 and the adjustable bolt 29 by virtue of adjusting the back and forth of the adjustable rod 29. Thereby the buffering as well as locking position of the door closer structure of the present invention may be adjustable without difficulties by virtue of the adjusting cover 28 and the adjustable rod 29.

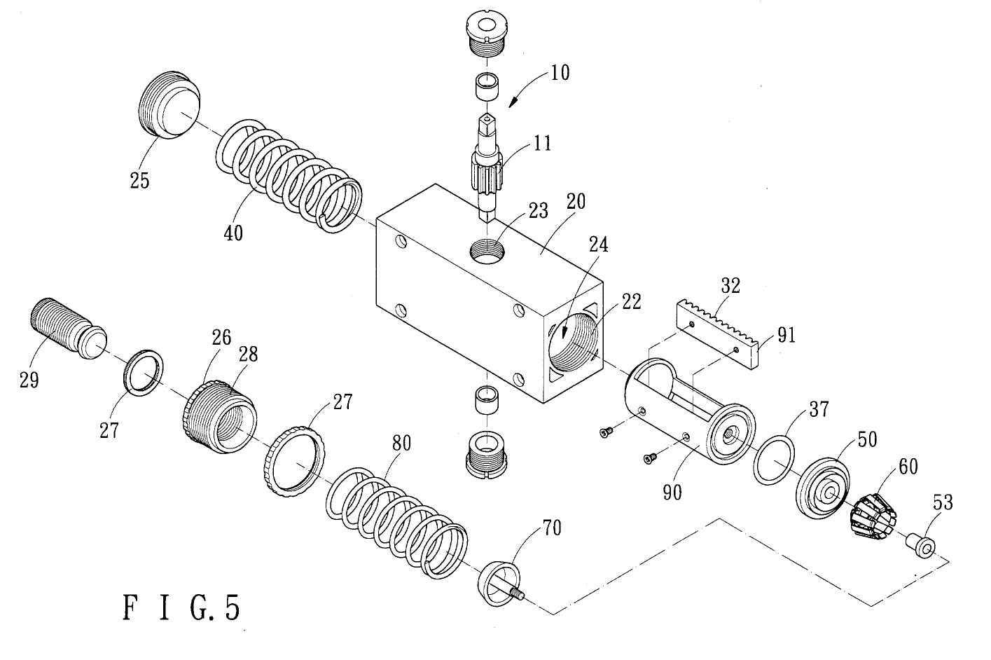

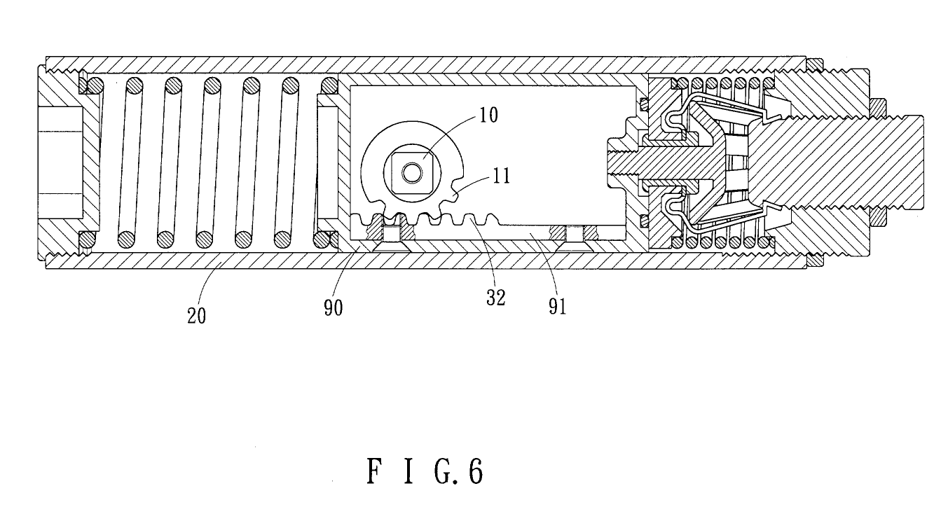

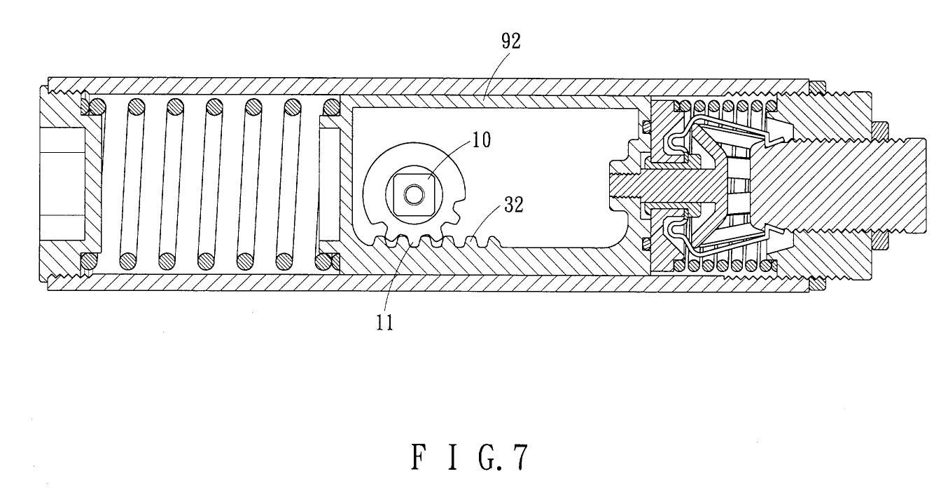

Referring to FIGS. 5-6, which shows a door closer structure in accordance with a second embodiment of the present invention, in which, the sliding member 30 of the present invention also can be consisted of a hollow member 90 and a plate 91. The plate 91 is provided with a plurality of teeth 32, while the toothed portion 11 of the door shaft 10 is received in the inner hollow space of the hollow member 90 with the toothed portion 11 engaging with the teeth 32 of the plate 91. With further referring to FIG. 7, which shows a door closer structure in accordance with a third embodiment of the present invention, in which, the sliding member 30 also can be a integrally formed hollow member 92 interiorly formed with a plurality of teeth 32.

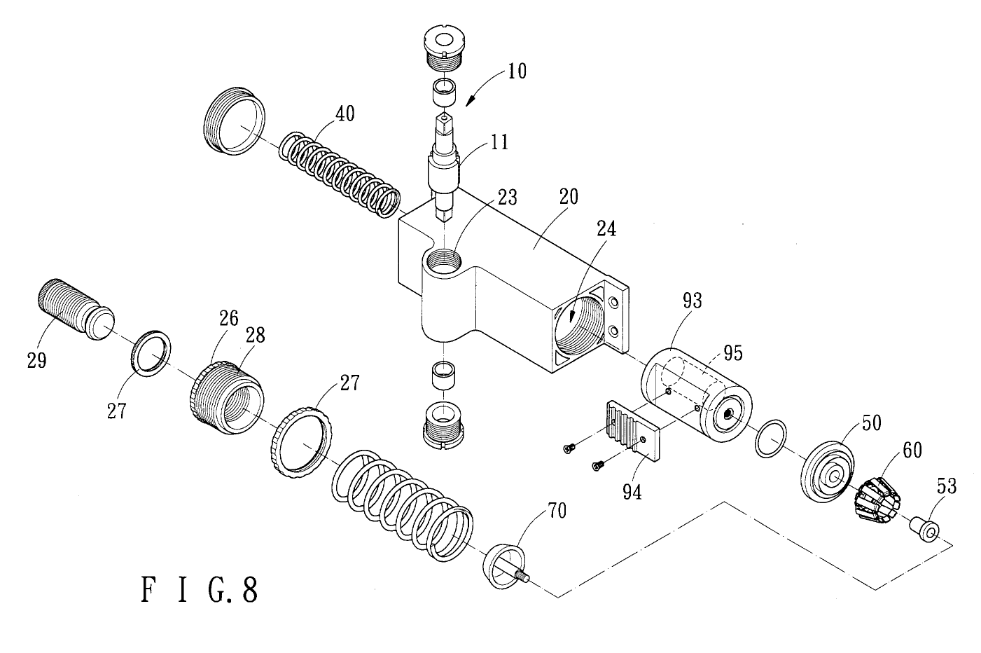

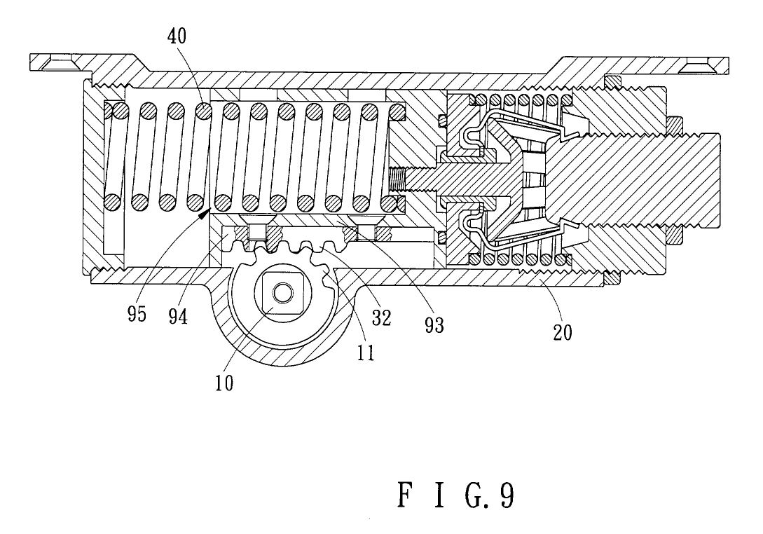

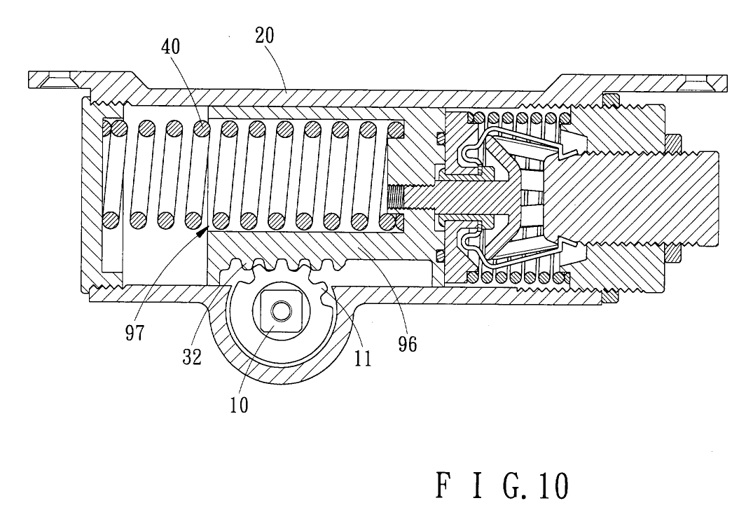

Referring now to FIGS. 8-9, which shows a door closer structure in accordance with a fourth embodiment of the present invention, in which, the sliding member 30 can be consisted of a tubular member 93 and a plate 94. The plate 94 is provided with a plurality of teeth 32, while the toothed portion 11 of the door shaft 10 is engaged with the teeth 32 of the plate 94 and the bore 95 of the tubular member 93 serves for accommodation of the door-closing spring 40. By such a manner, the allowable length of the door-closing spring 40 may be relatively lengthened (so as to reinforce the door-closing force). The FIG. 10 shows a door closer structure in accordance with a fifth embodiment of the present invention, in which, the sliding member of the present invention can be a tubular member 96 provided with a plurality of teeth 32. The bore 97 of the tubular member 96 serves for accommodation of the door-closing spring 40; by such a manner, the allowable length of the door-closing spring 40 may be relatively lengthened (so as to reinforce the door-closing force).

While we have shown and described various embodiments in accordance with the present invention, it should be clear to those skilled in the art that further embodiment may be made without departing from the scope of the present invention.

What is claimed is:

1. A door closer structure comprising: a door shaft, a housing, a sliding member, a door-closing spring, a claw, an abutting member and a door-opening spring, wherein:
the housing has an engaging portion interiorly defined thereof, in the housing the sliding member is slidably disposed and engaged with the door shaft simultaneously, the door-closing spring is tensioned between the housing and the flanged first end of the sliding member, the claw is slidably received in the housing and having a protruded portion formed at an end which is corresponding to the engaging portion of the housing, the abutting member is disposed at an end of the sliding member and having another end abutting against the claw, the abutting member is driven by the sliding member whereby to actuate the protruded portion, the door-opening spring tensioned between the housing and another end of the claw.

2. The door closer structure as claimed in claim 1 comprising: a door shaft, a housing, a sliding member, a door-closing spring, a sliding board, a claw, an abutting member and a door-opening spring, wherein:
the door shaft revolves along with the opening and closing action of the door, and is provided with a toothed portion;
the housing has an internal space interiorly defined thereof and at both ends of which is provided with a spring cover and a adjusting cover respectively, in the middle of the housing a hole is defined for receiving the door shaft therein, the adjusting cover has a threaded hole formed in the center of it, in which an adjustable bolt is engaged, at an end of the adjustable bolt where corresponding to the internal space of the housing is formed with a chamfer and contiguous to it an engaging portion defined thereof;
the sliding member is movably accommodated in the housing, the sliding member has a flanged first end and a second end formed with a threaded hole, and the sliding member is provided with a plurality of teeth at the outer periphery for engaging with the toothed portion of the door shaft;
the door-closing spring is employed to provide the force for closing door and tensioned between the spring cover of the housing and the flanged first end of the sliding member;
the sliding board is received in the housing with abutting against the sliding member, at the center of the sliding board is defined an aperture;
the claw is integrally formed by a plurality of plates, at the conjunction end of the whole plates is defined with an opening, while at another end of the same an open mouth is formed thereof, each plate has a protruded portion formed at the end where corresponding to the open mouth, with which corresponding to the engaging portion of the adjustable bolt of the housing, the opening of the claw is position-locked by virtue of the sliding board;
the abutting member is received in the housing, which has a rod at the end corresponding to the sliding member and an annular protrusion formed at the other end, the rod has threads defined at the end for engaging with the threaded hole of the sliding member, furthermore, the rod is movably inserted in the aperture of the sliding board with the annular protrusion abutting against the inner side of the plates of the claw;
the door-opening spring is employed to provide force for opening the door and tensioned between the adjusting cover of the housing and the sliding board.

3. The door closer structure as claimed in claim 2, wherein the housing is a hollow member being interiorly formed with internal space, and at both ends of which are provided with a first inner threads and a second inner threads respectively, in the first inner threads the spring cover is engaged, while the second inner threads is engaged with the adjusting cover.

4. The door closer structure as claimed in claim 2, wherein the sliding member consists of a hollow member and a plate, the plate is provided with a plurality of teeth, while the toothed portion of the door shaft is received in the internal space of the hollow member with the toothed portion engaged with the teeth of the plate.

5. The door closer structure as claimed in claim 2, wherein the sliding member is an integrally formed hollow member, at the inner side of the hollow member is defined with a plurality of teeth, while the toothed portion of the door shaft is engaged with the teeth on the inner side of the hollow member.

6. The door closer structure as claimed in claim 2, wherein the sliding member consists of a tubular member and a plate, the plate is provided with a plurality of teeth, while the toothed portion of the door shaft is engaged with the teeth of the plate, the bore of the tubular member for accommodation of the door-closing spring, whereby the allowable length of the door-closing spring may be relatively lengthened.

7. The door closer structure as claimed in claim 2, wherein the sliding member is a tubular member provided with a plurality of teeth, while the bore of the tubular member for accommodation of the door-closing spring, whereby the allowable length of the door-closing spring may be relatively lengthened.
